(19) United States
(12) Patent Application Publication
(10) Pub. No.: US 2007/0240118 A1
(43) Pub. Date: Oct. 11, 2007

(54) System, method, and software for testing a software application

(76) Inventor: Ido Keren, Hod Hasharon (IL)

Correspondence Address: FISH & RICHARDSON, P.C., PO BOX 1022, MINNEAPOLIS, MN, 55440-1022, US

(21) Appl. No.: 11/364,406

(22) Filed: Feb. 28, 2006

(51) Int. Cl. G06F 9/44

(52) U.S. Cl. 717/124

(57) ABSTRACT

A computer implemented method, system, and software is provided for testing a software application. In one embodiment, for example, the system is operable to invoke a recorder to monitor characteristics of a software application and automatically generate a script associated with the monitored characteristics of the existing software application.

### TECHNICAL FIELD

This disclosure generally involves data processing and, more particularly, a system, method, and software for testing a software application.

### BACKGROUND

Software development generally uses multiple iterations of testing to help ensure that the code is released with as few errors or bugs as feasible. This testing may involve multiple stages commonly termed alpha, beta, and so forth. In alpha, the developers normally run the programs through a number of manual tests. In beta, the current software may be released to a limited set of end users so that they can test the functionality before general release. Occasionally, before the software is released to end users, it may be subjected to somewhat automated tests that involve manually created code tailored for the particular software. Typically, this somewhat automated testing may be fairly slow, based on tables and metawords, and/or use poor or reduced-functionality user interfaces. Moreover, the tailored code is often complicated and indicates difficulties in creating and testing new scenarios.

### SUMMARY

This disclosure provides a method, software, or system for testing a software application. In one implementation, for example, a method includes invoking a recorder to monitor characteristics of a software application and automatically generating a script associated with the monitored characteristics of the existing software application. Other example methods may further include submitting the script to an automated tester and receiving testing results from the automated tester based on the software application and the script. In some cases, these testing results may then be compared to verified results to locate errors in the software application.

Certain methods may further include modifying the software application. For example, these methods may include submitting the script to the automated tester, receiving second testing results from the automated tester based on the modified software application and the script, and comparing the second testing results to the verified results to locate errors in the modified software application. In some cases, the recorder is may be invoked again to monitor the characteristics of the modified software application. A second script associated with the monitored characteristics of the executing modified software application is automatically generated.

The foregoing—as well as other disclosed—example methods may be computer implementable. Moreover some or all of these aspects may be further included in respective systems and software for testing other applications. The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of an example system for testing a software application in accordance with one embodiment of the present disclosure;

FIG. 2 is a diagram showing example components used for recording characteristics of the software application and for testing the software application using at least some of these recorded characteristics;

FIG. 3 is an example of a user interface of the software application to be tested;

FIG. 4 is an example of a data file structure for input data collected during a recording or otherwise used for automatic testing of the software application;

FIG. 5A is an example user interface of the recorder application after recording characteristics of the software application;

FIG. 5B is an example user interface of the recorder application after receiving user edits of recorded characteristics of the software application;

FIG. 5C is an example user interface of the recorder application showing data collected during the recording;

FIG. 6 is a flowchart illustrating an example method of operations that may be performed to record characteristics of the software application and test the software application;

FIG. 7 is an example of a user interface of an automated tester application; and

FIG. 8 is an example of a user interface of an automated tester application showing a flow diagram of tests within a particular test set.

### DETAILED DESCRIPTION

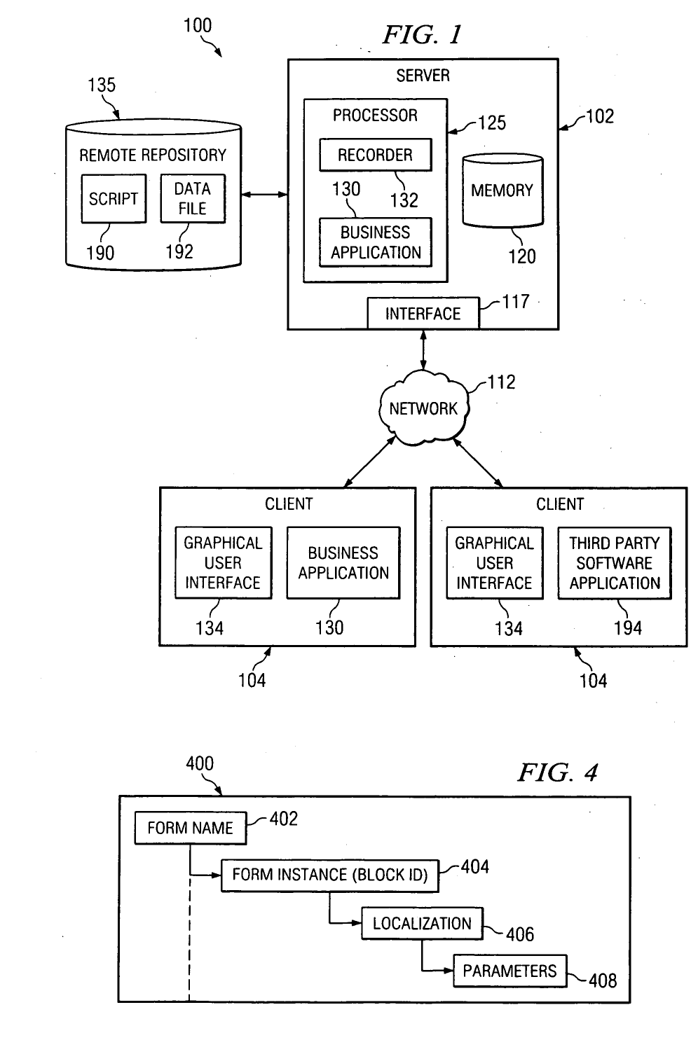

FIG. 1 shows an example system 100 for testing software applications, such as a business application 130, used by an example enterprise. In this example, certain components of system 100 may record characteristics of the software application, including data (both input and output), actions, time, metrics, operating system and related library parameters, initialization variables, registry values, and other information associated with business processes implemented by the application. These business processes may include company or user initialization, purchasing, sales, sales opportunities, production, material requirements planning (MRP), service or human resources (HR), financials and banking, and many others. This recorder is generally able to monitor the characteristics of various applications. These recording sessions may help these applications run faster or be more easily modified. Further, the disclosed recorder may reduce the time of creating new scenarios. Indeed, system 100 may allow the developers, testers, or other users to respond more quickly when a new build is released. The system 100 is typically a distributed client/server system that spans one or more networks, such as illustrated network 112. In such embodiments, data may be communicated or stored in an encrypted format using any standard or proprietary encryption algorithm. Alternatively, the system 100 may be in a dedicated enterprise environment—across a local area network or subnet—or any other suitable environment without departing from the scope of this disclosure. As illustrated, system 100 includes or is communicably coupled with server 102, one or more clients 104, and network 112.

Server 102 comprises an electronic computing device operable to receive, transmit, process and store data associated with system 100. Generally, FIG. 1 provides merely one example of computers that may be used with the disclosure. Each computer is generally intended to encompass any suitable processing device. For example, although FIG. 1 illustrates one server 102 that may be used with the disclosure, the system 100 can be implemented using computers other than servers, as well as a server pool. Indeed, the server 102 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. The server 102 may be adapted to execute any operating system including Linux, UNIX, Windows Server, or any other suitable operating system. According to one embodiment, the server 102 may also include or be communicably coupled with a web server and/or a mail server.

The illustrated server 102 includes a local memory 120. The memory 120 may include any memory or database module and may take the form of volatile or non-volatile memory including, without limitation, magnetic media, optical media, random access memory (RAM), read-only memory (ROM), removable media, or any other suitable local or remote memory component. The memory 120 may include some or all of application 130, some or all of recorder 132, and any other appropriate data such as VPN applications or services, firewall policies, a security or access log, print or other reporting files, HTML files or templates, data classes or object interfaces, related or unrelated software applications or sub-systems, and others.

The server 102 also includes a processor 125. The processor 125 executes instructions and manipulates data to perform the operations of the server 102 such as, for example, a central processing unit (CPU), a blade, an application specific integrated circuit (ASIC), or a field-programmable gate array (FPGA). Although, FIG. 1 illustrates a single processor 125 in server 102, multiple processors may be used according to particular needs and reference to the processor 125 is meant to include multiple processors where applicable. In the illustrated embodiment, processor 125 executes a business application 130.

At a high level, business application 130 is any application, program, module, process, or other software. In certain cases, the system 100 may implement a composite software application. In other cases, application 130 may be a batch program with a job submission interface or without an interface at all. Regardless of the particular implementation, “software” may include software, firmware, wired or programmed hardware, or any combination thereof as appropriate. Indeed, the business application 130 may be written or described in any appropriate computer language including C, C++, Java, J#, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. The business application 130 may include numerous sub-modules or may instead be a single multi-tasked module that implements various features and functionality through various objects, methods, or other processes. Further, while illustrated as internal to the server 102, one or more processes associated with the business application 130 may be stored, referenced, or executed remotely. For example, a portion of the business application 130 may be a web service that is remotely called, while another portion of the business application 130 may be an interface object bundled for processing at the remote client 104. Moreover, the business application 130 may be a child or sub-module of another software module or enterprise application (not illustrated) without departing from the scope of this disclosure. Indeed, the business application 130 may be a hosted solution that allows multiple parties in different portions of the process to perform the respective processing.

More specifically, the business application 130 may be a composite application, or an application built on other applications, that includes an object access layer (OAL) and a service layer. In this example, the business application 130 may execute or provide a number of business application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, the composite business application 130 may run on a heterogeneous IT platform. In doing so, the composite business application 130 may be cross-functional in that it may drive business processes across different applications, technologies, and organizations. Accordingly, the composite business application 130 may drive end-to-end business processes across heterogeneous systems or sub-systems. The business application 130 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application, it may instead be a standalone or (relatively) simple software program. Regardless, the business application 130 may also perform processing automatically, which may indicate that the appropriate processing is substantially performed by at least one component of the system 100. It should be understood that automatically further contemplates any suitable administrator or other user interaction with the business application 130 or other components of the system 100 without departing from the scope of this disclosure.

As illustrated (but not required), the server 102 is communicably coupled with a relatively remote repository 135 over a portion of the network 112. The repository 135 is any electronic storage facility, data processing center, or archive that may supplement or replace local memory. The repository 135 may be a central database communicably coupled with the one or more servers 102 and the clients 104 via a virtual private network (VPN), SSH (Secure Shell) tunnel, or other secure network connection. The repository 135 may be physically or logically located at any appropriate location including in one of the example enterprises or off-shore, so long as it remains operable to store information associated with the system 100 and communicate such data to the server 102 or at least a subset of plurality of the clients 104. Information associated with the system 100 may include, for example, a script 190 and a data file 192.

Recorder 132 may generate the script 190 and the data file 192 during a recording session. In some implementations, the recorder 132 is a standalone or distributed software module operable to record characteristics of the business application 130. The recorder 132 may operate within the client 104 or the server 102 and the recorder 132 may record characteristics of a business application operating at the client 104 or the server 102. The recorder 132 may be an invocable application with a friendly user interface or a component of such an application, such as a Dynamic Link Library (DLL) or an object. For example, recorder 132 may be implemented as two DLLS, Connection.dll and RecorderAccess.dll. The recorder 132 stores the recorded characteristics of the business application 130 in the script 190 and, occasionally, the data file 192. The script 190 and the data file 192 may then be used to test the business application 130. For example, the actions in the script 190 may simulate the actions of a user. The actions may be performed repeatedly over time as part of regression testing. Performing the actions in the script 190 may allow a testing application to determine the existence of software errors in a shorter amount of time, more accurately, and with less human interaction than if the user were to repeat the test manually. The actions in the script 190 may be performed immediately when it is determined that a test is needed. The recorded tests in the script 190 may be used to target a particular aspect of the operation of the business application 130, such as a feature that has been modified.

Script 190 may represent characteristics of the business application 130, such as events resulting from user interaction with the business application 130 or attributes describing the state of the business application 130. Script 190 may use any appropriate language capable of describing software application events and the state of the business application 130 with the goal of reproducing the events and the states by performing the actions in the script 190. For example, script 190 may be written using a language such as Java, Visual Basic, or Visual Basic Script. Performing the actions in the script 190 may form a testing scenario for the business application 130 based on previous processing by the user or automated test creation of this or another similar application. This script 190 may be edited by the user (whether end user, developer, or administrator). For example, the user can add code to the existing script 190 to handle options that cannot be (or weren't) recorded such as flags or other non-traversed conditions. Often, the script 190 is formatted in a logical manner corresponding to referenced portions in data file 192, which provides input to the test according to actions defined script 190. In other words, script 190 is modular or otherwise divided into small functions or functional groups that may be called by a managing sub-routine. As a result, the managing sub-routine normally contains only the calls to those functions in the order decided by the modifying user. Returning to the editing example, the user typically makes corresponding changes to data file 192 matching those edits in script 190.

Data file 192 generally includes one or more data inputs for subsequent tests and is generally associated, whether tightly or loosely, with script 190. Put another way, information in the data file 192 may be used in actions performed by the script 190, such as code operable to play back the actions of a user during a data input operation to the business application 130. For example, script 190 may load or invoke a particular data file 192 using commands similar to the following:

DataConnection.Load (“The data file path”)

DataConnection.BlockIDs.BlocksSequence=“block No.”

In this example, if the user decides (or it is automatically determined) to run a select group of blocks from data file:

DataConnection.BlockIDs.BlocksSequence=“0-5”
Or:
DataConnection.BlockIDs.BlocksSequence=“0, 1, 2, 3, 4, 5”
Or:
DataConnection.BlockIDs.BlocksSequence=“0, 2, 5”
   Data file 192 may be created using any suitable automatic or manual technique. For example, the data inputs may initially be those made by the user during the generation of the script 190. This user input may include key strokes, mouse movement and clicks, verbal commands, screen touches, or any other form of input captured by the recorder 132 from the user. In another example, the data file 192 may be created or modified by the user after creation of the script 190. In yet another example, the data file 192 may be created separately from script 190 during a second recording session of the same or similar application. For example, one user may be responsible for creating a testing scenario via script 190, which a second user may be responsible for creating the data to be used in this testing scenario. In this example, the first user may be a developer with knowledge of the software logic and the second user may be an end user with knowledge of how application 130 is used.

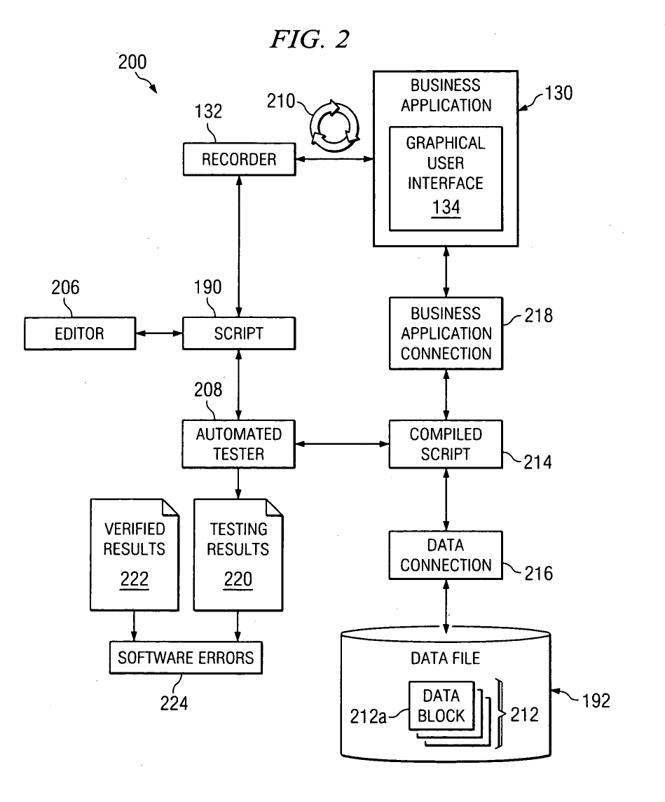

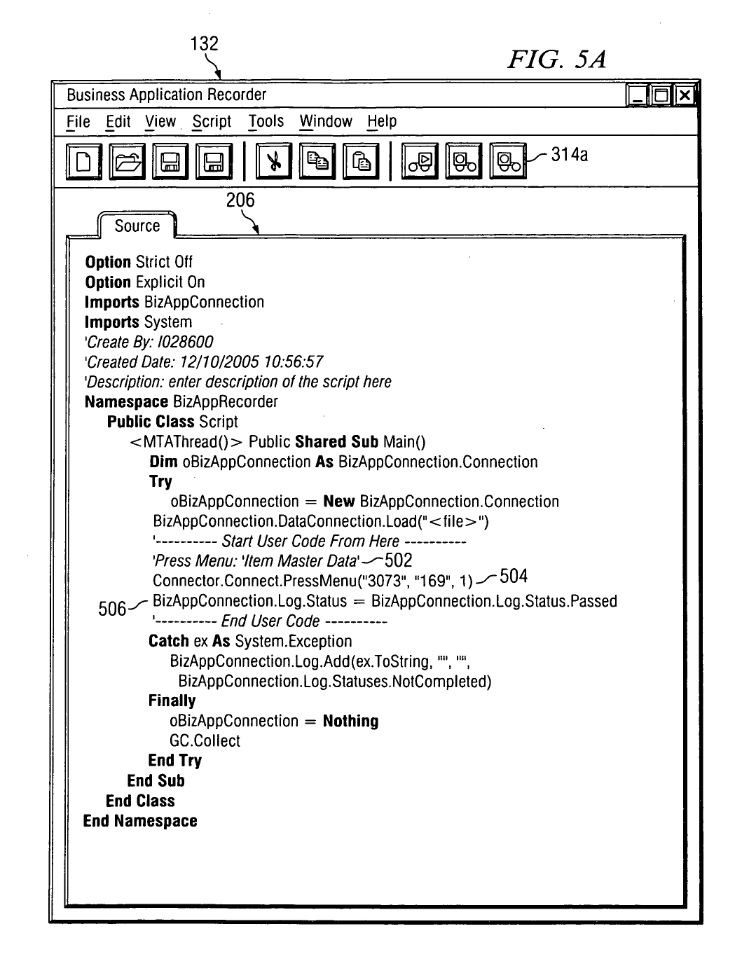

FIG. 4 shows one example of a data file structure 400 in a schematic form. At the highest level of this example, the data file 192 may include one or more blocks (illustrated as 212 in FIG. 2), each represented by a form name 402. A form name may correspond to, for example, a particular interface presented to the user via the particular application 130. The form name 402 may include one or more form instances 404. An instance may represent, for example, a particular block or other cycle of the testing scenario. For example, a particular form may be executed twice during a test of order entry and order returns. The instance 404 may include one or more localizations 406. A localization may represent, for example, a particular linguistic translation of the data inputs made by the user. The localization 406 may include one or more parameters 408. A parameter normally represents a particular data point or variable or other characteristics of the business application 130 that is recorded by the recorder 132, such as a particular data input made by the user. It will be understood that while described in terms of comprising four levels, data file 192 may have more or less logical levels without departing from the scope of this disclosure.

In some implementations, a structured or hierarchical language, such as XML, may be used to represent the blocks and levels via tags and such. For example, one such block within the data file 192 may follow the format shown below:

<form ID=“Item Master Data”>

<instance ID=1>

<localization ID=“DE”>

<parameter>Fügen Sie hinzu</parameter>

</localization>
<localization ID=“EN-US”>

<parameter>Add</parameter>

</localization>

</instance>
<instance ID=2>

<localization ID=“DE”>

<parameter>Nehmen Sie heraus</parameter>

</localization>
<localization ID=“EN-US”>

<parameter>Remove</parameter>

</localization>

</instance>
<instance ID=3>

<localization ID=“DE”>

<parameter>Aktualisierung</parameter>

</localization>
<localization ID=“EN-US”>

<parameter>Update</parameter>

</localization>

</instance>
<instance ID=4>

<localization ID=“DE”>

<parameter>Kopie</parameter>

</localization>
<localization ID=“EN-US”>

<parameter>Duplicate</parameter>

</localization

</instance>

</form>

In the example above, first block 212a is represented at the highest level by a <form> tag having a “name” attribute of “Item Master Data.” The “Item Master Data”<form> tag includes <instance> tags corresponding to each of the different selections made in the “Item Master Data” form. Each <instance> tag includes an “identifier (ID)” attribute, 1, 2, 3, and 4 corresponding to four instances of user inputs made in the “Item Master Data” form. The <instance> tags each include one or more <localization> tags. The <localization> tags include a “name” attribute describing the name of the localization, such as “EN-US” for English-United States and “DE” for German. The <localization> tags include one or more <parameter> tags that describe the actual data parameter received by the business application 130 during the monitoring by the recorder 132. For example, the contents of the fourth instance of the “Item Master Data” form parameter include “Duplicate” in an English localization and “Kopie” in a German localization. Of course, it will be understood that the foregoing description involves merely an example of such a data file 192. In other words, data file 192 may be any suitable file type that includes the appropriate data in any suitable format and may be stored using any suitable storage technique. For example, data file 192 may store information as one or more tables in a relational database described in terms of SQL statements or scripts. In another embodiment, data file 192 may store information as various data structures in text files, eXtensible Markup Language (XML) documents, Virtual Storage Access Method (VSAM) files, flat files, Btrieve files, comma-separated-value (CSV) files, internal variables, or one or more libraries. But any stored information may comprise one table or file or a plurality of tables or files stored on one computer or across a plurality of computers in any appropriate format. Indeed, some or all of the input data may be local or remote without departing from the scope of this disclosure and store any type of appropriate data.

Returning to FIG. 1, server 102 may also include an interface 117 for communicating with other computer systems, such as clients 104, over the network 112 in a client-server or other distributed environment. In certain embodiments, server 102 receives data from internal or external senders through the interface 117 for storage in the memory 120 and/or processing by the processor 125. Generally, interface 117 comprises logic encoded in software and/or hardware in a suitable combination and operable to communicate with the network 112. More specifically, interface 117 may comprise software supporting one or more communications protocols associated with the communications network 112 or hardware operable to communicate physical signals.

The network 112 facilitates wireless or wireline communication between the computer server 102 and any other local or remote computer, such as clients 104. The network 112 may be all or a portion of an enterprise or secured network. In another example, the network 112 may be a VPN between the server 102 and the client 104 across wireline or wireless link. Such an example wireless link may be via 802.11a, 802.11b, 802.11 g, 802.20, WiMax, and many others. While illustrated as a single or continuous network, the network 112 may be logically divided into various sub-nets or virtual networks without departing from the scope of this disclosure, so long as at least portion of the network 112 may facilitate communications between the server 102 and at least one of the clients 104. For example, server 102 may be communicably coupled to the repository 135 through one sub-net while communicably coupled to a particular client through another. In other words, network 112 encompasses any internal or external network, networks, sub-network, or combination thereof operable to facilitate communications between various computing components in the system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 112 may be a secure network associated with the enterprise, which can include the local or remote clients 104.

Client 104 is any computing device operable to connect or communicate with the server 102 or the network 112 using any communication link. For example, one client 104 may be located in a region that uses a language other than the language used by those near the server 102, while another client 104 may be located relatively locally to server 102. At a high level, each of the clients 104 includes or executes at least a graphical user interface (GUI) 134 and comprises an electronic computing device operable to receive, transmit, process and store any appropriate data associated with the system 100. It will be understood that there may be any number of clients 104 communicably coupled to the server 102. Further, “client 104” and “user” may be used interchangeably as appropriate without departing from the scope of this disclosure. Moreover, for ease of illustration, each of the clients 104 is described in terms of being used by one user. However, this disclosure contemplates that many users may use one computer or that one user may use multiple computers. As used in this disclosure, client 104 is intended to encompass a personal computer, touch screen terminal, workstation, network computer, kiosk, wireless data port, smart phone, personal data assistant (PDA), one or more processors within these or other devices, or any other suitable processing device. For example, client 104 may be a PDA operable to wirelessly connect with external or unsecured network. In another example, the client 104 may comprise a laptop that includes an input device, such as a keypad, touch screen, mouse, or other device that can accept information, and an output device that conveys information associated with the operation of the server 102 or the clients 104, including digital data, visual information, or the GUI 134. Both the input device and output device may include fixed or removable storage media such as a magnetic computer disk, CD-ROM, or other suitable media to both receive input from and provide output to users of the clients 104 through the display, namely the client portion of the GUI 134.

GUI 134 comprises a graphical user interface operable to allow the user of the client 104 to interface with at least a portion of the system 100 for any suitable purpose, such as viewing application or other transaction data. Generally, GUI 134 provides the particular user with an efficient and user-friendly presentation of data provided by or communicated within the system 100. GUI 134 may comprise a plurality of customizable frames or views having interactive fields, pull-down lists, and buttons operated by the user. GUI 134 may also present a plurality of portals or dashboards. It should be understood that the term graphical user interface may be used in the singular or in the plural to describe one or more graphical user interfaces and each of the displays of a particular graphical user interface. Indeed, reference to the GUI 134 may indicate a reference to the front-end or a component of the business application 130, as well as the particular interface accessible via the client 104, as appropriate, without departing from the scope of this disclosure. Therefore, GUI 134 contemplates any graphical user interface, such as a generic web browser or touch screen, that processes information in the system 100 and efficiently presents the results to the user. Server 102 can accept data from client 104 via the web browser (e.g., Microsoft Internet Explorer or Netscape Navigator) and return the appropriate HTML or XML responses to the browser using the network 112.

Additionally, client 104 may include local applications and a local version of recorder 132 for a pointer to the distributed recorder. In other words, client 104 may include applications that may be tested via scripts 190 generated by recorder 132. For example, first client 104 may execute a first operating system that runs a component or front end of business application 130. This instance of the business application 130 may be a different localization, a different version, or otherwise similar yet distinct from that used to generate the script 190 and/or data file 192. The characteristics may include localizations due to, for example, the language of the user. Furthering the example, second client 104 may execute a second operating system with a third party software application 194. Third party software application 194 is typically a standalone application independent of the business application 130. Characteristics of the third party software application 194 may also be recorded in the script 190 and the data file 192 in replacement of—or a supplement to—that data and script actions defined by business application 130. Sometimes, the script generated by the monitoring of application 130 may be used to test third party software application 194.

FIG. 2 is a block diagram of an example of a software environment 200 used for recording characteristics of a local or remote software application and for testing the software application. For example, the environment 200 includes a software application (such as the business application 130 or third party software application 194), the recorder 132, an editor 206, and an automated tester 208. It will be understood that while the procedures and techniques are described using business application 130, any software application (whether standard or not) may be tested.

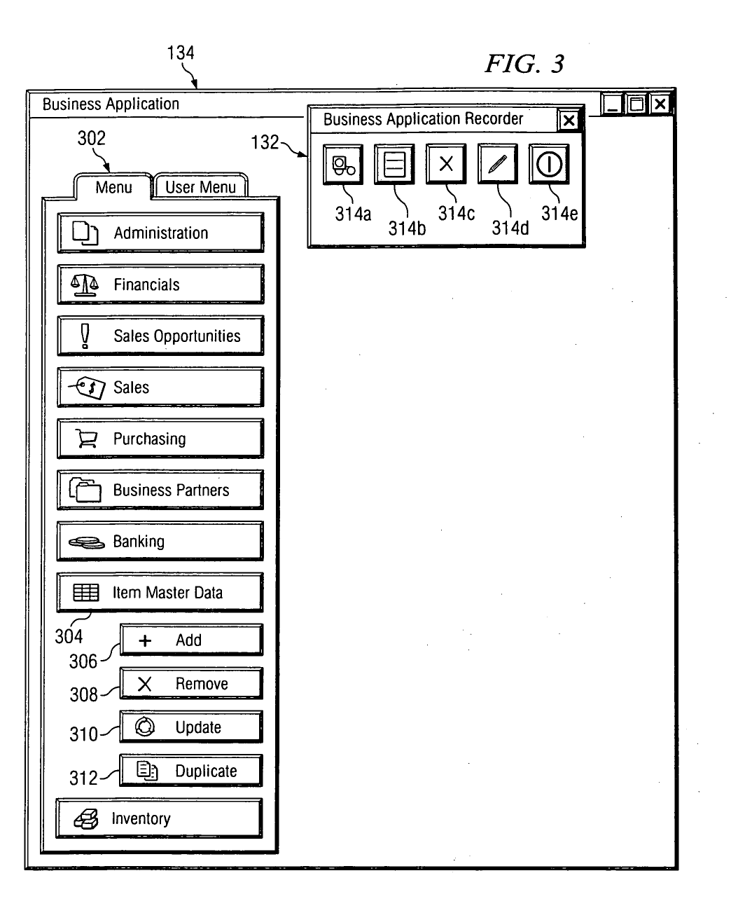

Business application 130 presents the GUI 134 to the user. GUI 134 may allow the user to interact with the business application 130, such as by accepting user inputs, providing means for navigation within the GUI 134, and presenting information regarding the system 100. For example, FIG. 3 provides one sample of such a front end of business application 130. The illustrated GUI 134 includes a menu 302 having input controls that allow the user to navigate among user interfaces provided by business application 130. Particularly, the menu 302 includes an “Item Master Data” control 304 that allows the user to navigate to an “Item Master Data” user interface. The control 304 has associated sub-controls 306, 308, 310, and 312 that allow the user to add, remove, update, and duplicate, respectively, an item in the Item Master Data user interface.

As shown, recorder 132 is often operable to present user-friendly controls 314a-e. This user interface may be automatically embedded in or linked to the front end of the monitored business application or a separate interface as appropriate. The control 314a may allow the user to toggle monitoring on and off. The control 314b may allow the user to compare blocks within the script 190 to one another. The control 314c may allow the user to remove the currently monitored block. The control 314d may allow the user to add a comment to the currently monitored block. The control 314e may allow the user to exit monitoring mode. In some implementations, the recorder 132 may perform its actions while hidden from the user without presenting the controls 314e-e to the user. For example, the recorder 132 may be used in a blind test where the user does not know that his actions are being recorded for the purpose of testing the business application 130.

Returning to FIG. 2, characteristics of the user's interaction with business application 130 are monitored by the recorder 132, as represented by arrows 210. The user of business application 130 may invoke the recorder 132. In some implementations, the recorder 132 may be invoked automatically upon initialization of the business application 130. The monitoring of the characteristics by the recorder 132 may be terminated by the user or may occur in a manner hidden from the user. Recorder 132 automatically generates the script 190 based on the monitored characteristics of the business application 130. In some implementations, recorder 132 terminates the monitoring and generates the script 190 after completion of the execution of the business application 130.

Script 190 may contain multiple functional groups, each corresponding to a block in data file 192. Each block is typically associated with one cycle of the execution of the business application 130. For example, a cycle of the execution of the business application 130 may include a user input that selects the “Item Master Data” control 304. In some cases, data file 192 may contain a hierarchy of four levels including a form level, a form instance level, a localized form instance level, and a localized form instance parameters level. The form level represents a particular user interface where user interaction may occur, such as the “Item Master Data” form. The “Item Master Data” form may have one or more instances representing distinct instances of the “Item Master Data” form. For example, in a first instance of a form the user may input a particular set of data and in a second instance of the same form the user may input a different set of data. The localization of the form instance represents differences between two copies of the same form instance. A form instance may have one or more localizations. Typically, the localizations of a form instance are based on the languages of the users as presented in the user interface. For example, a selection in a data field of a form instance, such as a “Duplicate” operation, made by a first user using a first language may be different than the same selection, here a “Kopie” operation, made by a second user using a second language. In this example, the first localization may represent an English language localization and the second localization may represent a German language localization. The parameter level is the actual data used by the business application 130 or the script 190, such as “Duplicate” or “Kopie.” Of course, as described above, data file 192 may have more or less logical levels without departing from the scope of this disclosure.

After recorder 132 generates the script 190, the user may request or invoke the editor 206. The editor 206 allows the user to make edits to the script 190 using any suitable technique. For example, the user may add actions to the script 190 that were not included during the monitoring of the business application 130. In another example, the user may add other conditions to test, select different associated parameters from data file 192, and such.

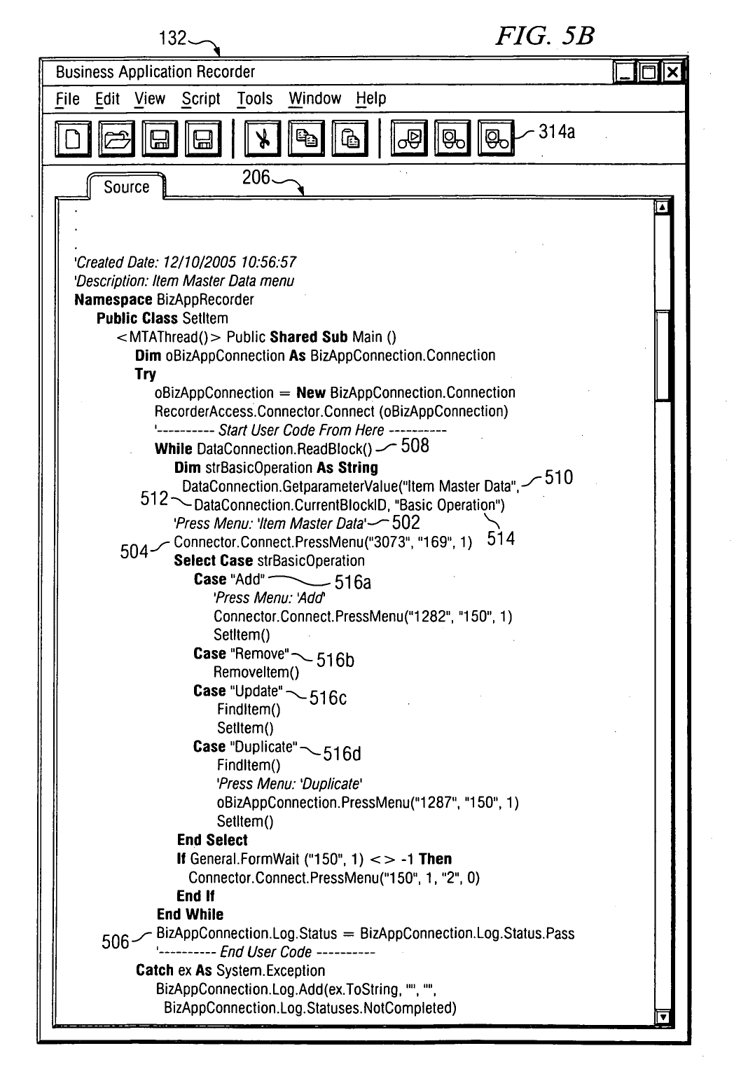

FIG. 5A is an example of a user interface of the recorder 132 after recording characteristics of the business application 130 and generating the script 190. The user interface includes the editor 206, which presents the script 190 generated by the recorder 132. The script 190 includes a comment 502 made by the user identifying the action performed. For example, before selecting the “Item Master Data” control 304, the user may select the comment control 314d and input the comment 502, such as “Press Menu: ‘Item Master Data.’” The script 190 also includes an action 504 representing a characteristic monitored by the recorder 132. Here, the action 504 is a user input with a pointing device that selects in the menu 302 the “Item Master Data” control 304. Following the execution of the action 504 within the script 190 is a log message 506 indicating the results of the action 504.

FIG. 5B is an example of a user interface of the recorder 132 after receiving user edits of the script 190. Here, the user has modified the script 190 to read data from the data file 192 that indicates other menu selections to be made. The script 190 successively reads blocks of data from the data file 192 using a “ReadBlock” command 508. A particular parameter is read from the data file 192 using a “GetParameterValue” command. The “GetParameterValue” command includes the form name “Item Master Data” 510, the form instance “CurrentBlockID” 512, and the parameter name “Basic Operation” 514. If the “Basic Operation” parameter in the data file 192 has a value of “Add,” then the actions in an “Add” case 516a are performed. If the “Basic Operation” parameter in the data file 192 has a value of “Remove,” “Update,” or “Duplicate,” then the actions in a “Remove” case 516b, an “Update” case 516c, or a “Duplicate” case 516d are performed, respectively.

Returning to FIG. 2, after generating the script 190 and receiving any edits to the script 190, the recorder 132 submits the script 204 to the automated tester 208. Automated test 208 may also be operable to creates reports at the end of each running, provide clear results after each running (such as green light when the test passes and red light with the reason when the test fails), and easily loads scripts and the data that was created by recorder 132. The automated tester 208 initiates or performs operations to execute the actions contained in the script 190 for the purpose of testing the business application 130. Executing the actions contained in the script 190 may include compiling the script 190 into a compiled script 214 in a format capable of being executed, for example, by the processor 125.

The compiled script 214 may access the data file 192 via a data connection 216. The data connection 216 may be an application program interface (API) that provides functions accessing the data file 192. The compiled script 214 may interact with the business application 130 via a business application connection 218. The business application connection 218 may be an API that provides access to the business application 130. The compiled script 214 may send the results log message 506 to the automated tester 208. The automated tester 208 may store and present the log messages in a testing results report 220. The testing results report 220 maybe compared to a verified results report 222 to determine if any software errors 224 occurred during the testing of the business application 130.

FIG. 5C is an example of a user interface of the recorder 132 showing the data file 192 used by the script 190 within the editor 206. The editor 206 includes a tree 518 that presents the forms, the instances of the forms, the localizations of the instances, and the parameters within the localizations. Here, the editor 206 shows that a “Germany” localization 520 of the first instance of the Item Master Data form is selected. The editor 206 presents parameters included in the selected localization 520. Particularly, each parameter may have a unique identifier, a description, and a value. In this example, the Germany localization 520 of the first Item Master Data instance has a parameter with a unique identifier 522a of “AddIMD1DE,” a description 522b of “Add,” and a value of “Fügen Sie hinzu.” The user may modify the data file 192 using editing controls 524a-d. For example, the user may add, remove, move up, or move down a parameter in the data file 192 using the controls 524a-d, respectively. A save control 526 allows the user to save the script 190 and the data file 192. For example, the user may select the control 526 and save the script 190 and the data file 192 as a test named “SetltemMasterData.” The SetItemMasterData test may then be used by the automated tester 208.

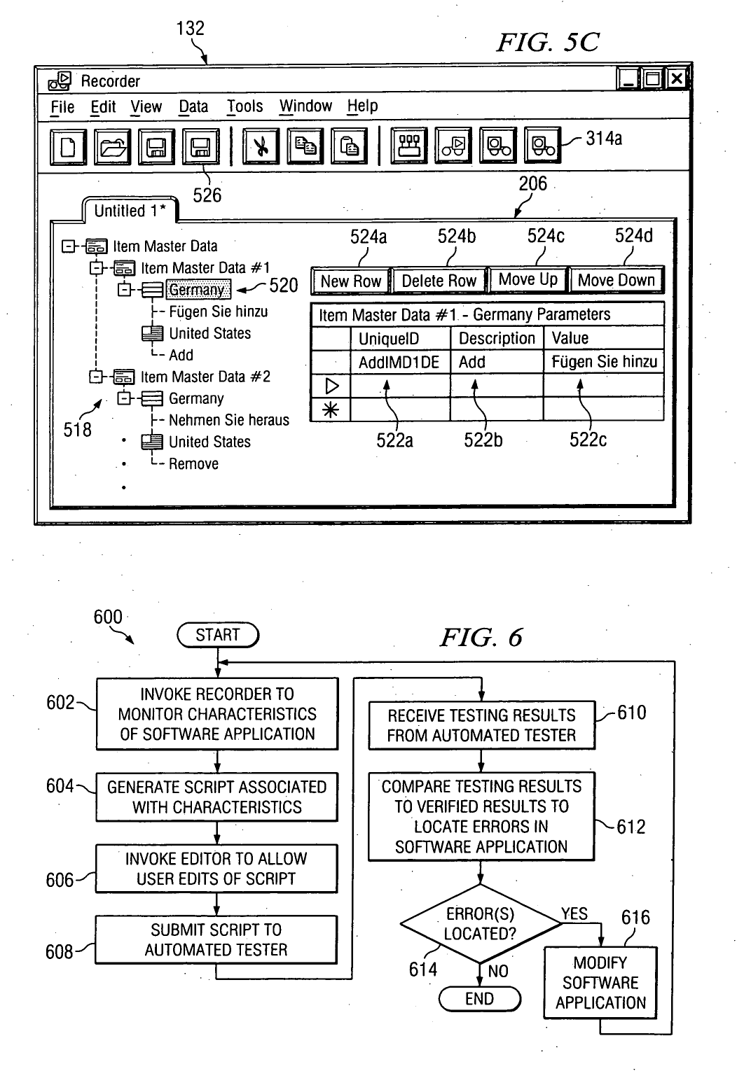

FIG. 6 shows method 600 for testing a software application. Method 600 may be computer-implementable, generally meaning that at least some portion is performed via client 104, server 102, or some other computer within system 100 and, for clarity, the following description uses system 100 as the example for describing method 600. However, another system, or combination of systems, may be used to perform method 600.

Method 600 begins at step 602 with invoking a recorder to monitor characteristics of a software program. For example, the recorder 132 may be invoked by a user or the recorder 132 may be invoked automatically upon initialization of the business application 130. At step 604, a script associated with the monitored characteristics of the software application is automatically generated. For example, the recorder 132 may generate the script 190. An editor operable to allow user edits of the script is invoked, at step 606. For example, the recorder 132 invokes the editor 206 to allow the user to edit the script 190. The script is submitted or otherwise transmitted, at step 608, to an automated tester along with any associated data file 192. For example, recorder 132 may automatically submit the script 190 to the automated tester 208.

At step 610, testing results are received from the automated tester 208. For example, the compiled script 214 may send log messages to the automated tester 208 and the automated tester 208 may present the log messages in a testing results report 220. The testing results are compared, at step 612, to verified results to locate errors in the software application. These verified results may be the original values present during recording, expected values, or any other results that can be used for at least partially verifying the output of the testing scenario. For example, a log message indicating failure following an “Add” action may indicate an error in processing of the “Basic Operation” parameter by the business application 130. In another example, an end user may input or import results determined elsewhere into a table or other matrix for use as verified results.

If errors are not located in the software application, then method 600 may terminate. If, at decisional step 614, errors are located in the software application, then the software application may be modified at step 616 to correct such errors. This modification may be requested or performed by the same user. Moreover, the modification may include any appropriate steps such as compiling, manual testing, and others. After the software application is modified in step 616, method 600 returns to step 602. For example, method 600 may be an iterative process that continues until the testing is performed without identifiable errors in the software application. In some implementations, step 616 may return to a step other than step 602, such as step 606 or 608. Particularly, the testing may reuse a previously generated script 190 and data file 192 or a previously generated script may be edited after testing and the testing may be performed again.

The preceding flowchart and accompanying description illustrate exemplary method 600. System 100 contemplates using or implementing any suitable technique for performing these and other tasks. It will be understood that this method is for illustration purposes only and that the described or similar processes and techniques may be performed at any appropriate time, including concurrently, individually, or in combination. For example, the software application and the recorder may be executed or otherwise invoked concurrently. In addition, many of the steps in this flowchart may take place simultaneously and/or in different orders than as shown. Moreover, system 100 may use or implement similar methods with additional steps, fewer steps, and/or different steps, so long as the methods remain appropriate. For example, if the testing does not locate any errors of a particular magnitude or within a certain threshold, then the application may not be modified and retested.

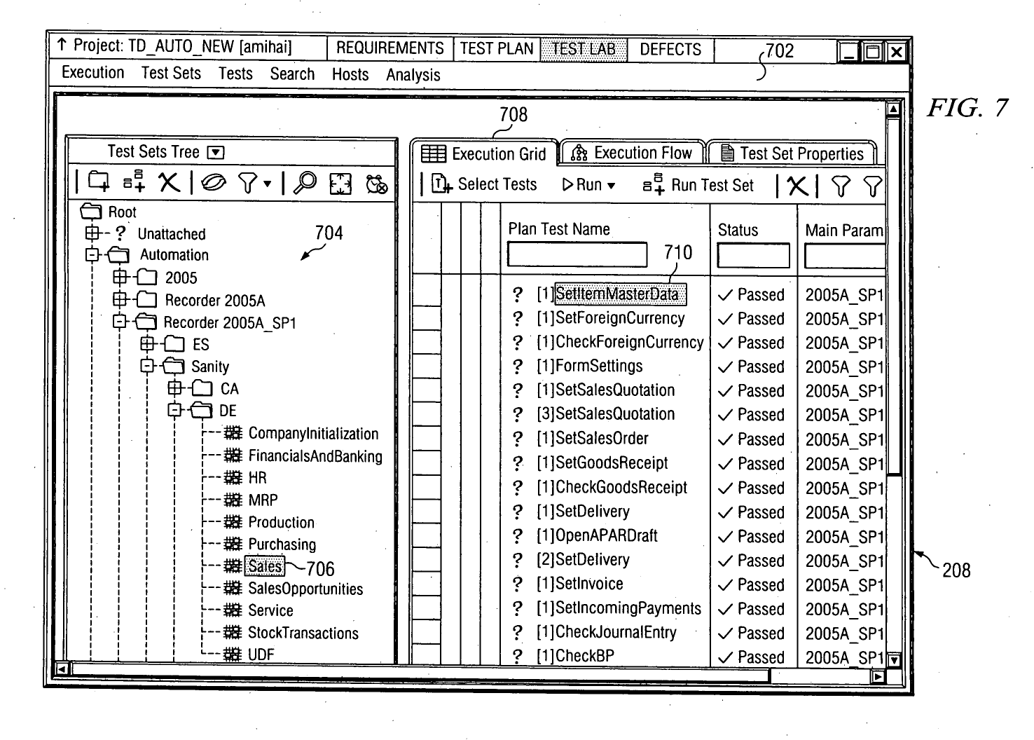

FIG. 7 shows a user interface of the automated tester 208. The automated tester 208 presents a test lab area 702 that allows the user to review, manage, and initiate sets of tests. The test lab area 702 includes a tree 704 that presents the sets of tests. Here, the tree 704 includes a “Sales” test set 706, which has been selected by the user. The “Sales” test set 706 may include tests related to sales operations performed by the business application 130. An execution grid area 708 presents individual tests within the selected Sales test set 706. Particularly, the “Sales” test set 706 includes the “SetItemMasterData” test 710. The execution grid 708 includes controls that allow the user to mange the tests within a test set, such as by adding, removing, or initiating a test or test set. In addition, the execution grid 708 presents an indication of the status of tests performed.

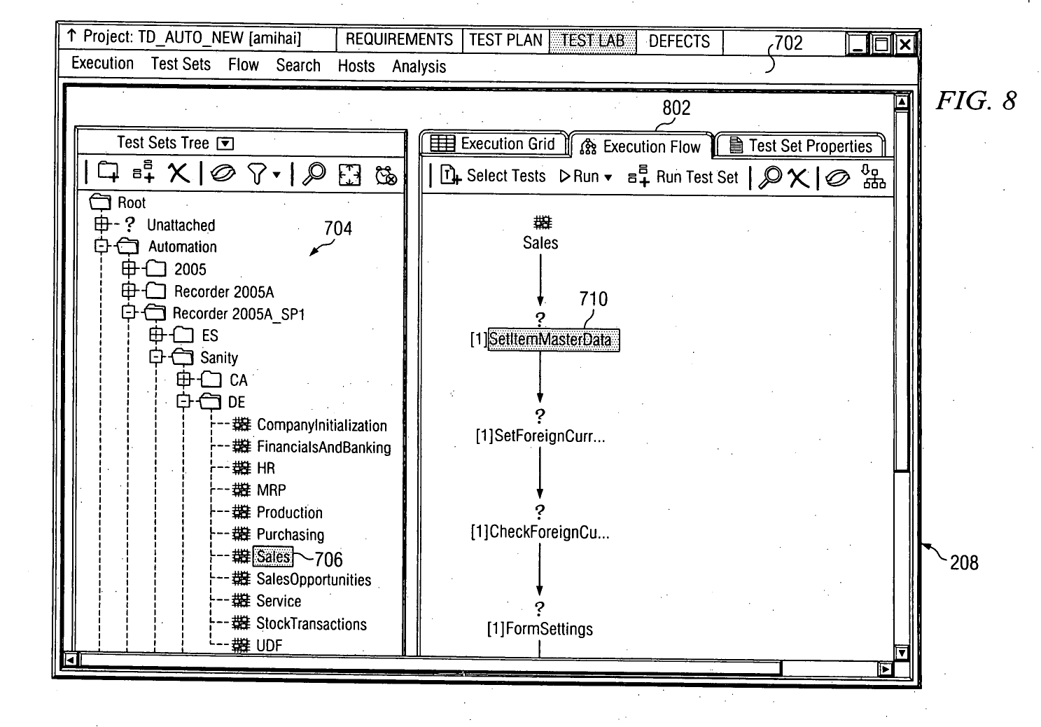

FIG. 8 shows a user interface of the automated tester 208 including an execution flow area 802. The execution flow area 802 presents a flow chart of the tests within a test set, such as the Sales test set 706. Here, the SetItemMasterData test 710 is performed first with each subsequent test performed in a serial method. In another example, some tests may be performed in parallel or the flow of the test set may branch into multiple paths. The execution flow area 802 includes controls that allow the user to manage the tests within a test set, such as by adding removing, or initiating a test or test set. In addition, the user may modify the structure of the flow chart to change how the automated tester 208 performs the tests. For example, the user may drag and drop a test to a new location in the flow chart.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the scope of this disclosure.

What is claimed is:

1. A computer implemented method for testing a software application, comprising:
invoking a recorder to monitor characteristics of software application; and
automatically generating a script associated with the monitored characteristics of the software application for testing the application.

2. The method of claim 1, further comprising invoking an editor operable to allow user edits to the script.

3. The method of claim 1, the script comprising a plurality of logical sub-modules associated with blocks from an input data file, each block of the data file associated with one of a plurality of cycles of a testing scenario.

4. The method of claim 3, the input data file arranged in a hierarchy comprising four levels; and
wherein the first level is associated with a form of the software application, the second level is associated with a form instance of the form, the third level is associated with a localization of the form instance, and the fourth level is associated with parameters of the localization.

5. The method of claim 1, the recorder being invoked automatically upon software initialization and the method further comprising automatically loading a data file to run through the software application.

6. The method of claim 5, the recorder running hidden from a user.

7. The method of claim 1, the software application comprising a business application and the characteristics comprising information associated with business processes.

8. The method of claim 1, further comprising:
submitting the script to an automated tester; and
receiving testing results from the automated tester based on the software application and the script.

9. The method of claim 8, further comprising comparing the testing results to verified results to locate errors in the software application.

10. The method of claim 9, the software application comprising a first software application and the method further comprising:
submitting the script to an automated tester;
receiving second testing results from the automated tester based on a second software application and the script, the second software application; and
comparing the second testing results to verified results to locate errors in the software application.

11. The method of claim 9, further comprising:
modifying the software application;
submitting the script to the automated tester;
receiving second testing results from the automated tester based on the modified software application and the script; and
comparing the second testing results to the verified results to locates errors in the modified software application.

12. Software for testing a software application comprising computer readable instructions operable to:
monitor characteristics of an executing software application; and
automatically generate a script associated with the monitored characteristics of the executing software application.

13. The software of claim 12 further operable to invoke an editor operable to allow user edits to the script.

14. The software of claim 12, the script comprising a plurality of logical sub-modules associated with blocks from an input data file, each block of the data file associated with one of a plurality of cycles of a testing scenario.

15. The software of claim 14, the input data file arranged in a hierarchy comprising four levels; and
wherein the first level is associated with a form of the software application, the second level is associated with a form instance of the form, the third level is associated with a localization of the form instance, and the fourth level is associated with parameters of the localization.

16. The software of claim 12, the recorder being invoked automatically upon software initialization and the software further operable to automatically load a data file to run through the software application.

17. The software of claim 16, the recorder running hidden from a user.

18. The software of claim 12, the software application comprising a business application and the characteristics comprising information associated with business processes.

19. The software of claim 12, further operable to:
transmit the script to an automated tester; and
receive testing results from the automated tester based on the software application and the script.

20. The software of claim 19, further operable to compare the testing results to verified results to locate errors in the software application.

21. The software of claim 20, the software application comprising a first software application and the software further operable to:
transmit the script to an automated tester;
receive second testing results from the automated tester based on a second software application and the script, the second software application; and
compare the second testing results to verified results to locate errors in the software application.

22. The software of claim 20, further operable to:
identify that the software application has been modified;
transmit the script to the automated tester;
receive second testing results from the automated tester based on the modified software application and the script; and
compare the second testing results to the verified results to locates errors in the modified software application.

23. A system for testing a software application comprising:
memory storing a recorder and a software application, the software application comprising an enterprise application; and
one or more processors operable to:
invoke the recorder to monitor characteristics of the software application, the software application comprising an enterprise application; and
automatically generate a script associated with the monitored characteristics of the software application.

24. The system of claim 23, the one or more processors further operable to execute an editor operable to allow user edits to the script.

25. The system of claim 23, the script comprising a plurality of logical sub-modules associated with blocks from an input data file, each block of the data file associated with one of a plurality of cycles of a testing scenario.

26. The system of claim 25, the input data file arranged in a hierarchy comprising four levels; and
wherein the first level is associated with a form of the software application, the second level is associated with a form instance of the form, the third level is associated with a localization of the form instance, and the fourth level is associated with parameters of the localization.

27. The system of claim 23, the recorder being invoked automatically upon software initialization and the system further operable to automatically load a data file to run through the software application.

28. The system of claim 27, the software application comprising a first application operable to run on a first operating system and the recorder comprising a dynamic link library (DLL) compatible with the first software application and a second application operable to run on a second operating system.

29. The system of claim 23, the software application comprising a business application and the characteristics comprising information associated with business processes.

30. The system of claim 23, the one or more processors operable to:
submit the script to an automated tester; and
receive testing results from the automated tester based on the software application and the script.

31. The system of claim 30, the one or more processors operable to compare the testing results to verified results to locate errors in the software application.

32. The system of claim 31, the software application comprising a first software application and the one or more processors further operable to:
submit the script to an automated tester;
receive second testing results from the automated tester based on a second software application and the script, the second software application; and
compare the second testing results to verified results to locate errors in the software application.

33. The system of claim 32, the one or more processors operable to:
modify the software application based on user input;
submit the script to the automated tester;
receive second testing results from the automated tester based on the modified software application and the script; and
compare the second testing results to the verified results to locates errors in the modified software application.
